(19) United States
(12) Patent Application Publication
(10) Pub. No.: US 2024/0187025 A1
(43) Pub. Date: Jun. 6, 2024

(54) FEEDFORWARD DISTORTION CANCELLATION APPARATUS AND METHOD

(71) Applicants: Innophase, Inc., San Diego, CA (US); Parallel Wireless, Inc., Nashua, NH (US)

(72) Inventors: Christopher Mobbs, Nashua, NH (US); Yang Xu, San Diego, CA (US)

(21) Appl. No.: 18/528,530

(22) Filed: Dec. 4, 2023

Related U.S. Application Data
(60) Provisional application No. 63/385,767, filed on Dec. 2, 2022.

(51) Int. Cl. H04B 1/04

(52) U.S. Cl. CPC H04B 1/0475; H04B 2001/0441

(57) ABSTRACT

An apparatus and a method include receiving, by a transmitter integrated circuit (IC) having a serial data communications interface, a digital transmit signal, and generating a first signal that is an analog radio frequency (RF) modulated signal based on the digital transmit signal and a second signal that is a phase-offset version of the first signal. An amplified signal is generated by amplifying the first signal and includes an amplified version of the first signal and an out-of-band distortion signal. A reduced-power signal is generated from the amplified signal. The reduced-power signal is subtracted from the second signal to output a distortion cancellation signal. An amplified distortion cancellation signal is generated by amplifying the distortion cancellation signal using an error amplifier. The amplified distortion cancellation signal and a delayed version of the amplified signal are combined to output an amplified version of the first signal with reduced distortion.

### CROSS-REFERENCE TO RELATED APPLICATIONS

This application claims the benefit of U.S. Application No. 63/385,767, filed Dec. 2, 2022, entitled “FEEDFORWARD DISTORTION CANCELLATION APPARAGTUS AND METHOD”, which is hereby incorporated herein by reference in its entirety for all purposes.

### BACKGROUND

The present disclosure relates to the field of telecommunications, and more specifically to a distortion cancellation in signals for transmission over antenna radiating elements. Applications may be found in the field of wireless communications such as 2G/3G/4G, LTE, LTE Advanced, and 5G, and the like.

Some schemes eliminate out-of-band distortion using a filter to remove or reduce out-of-band distortion from an amplified signal. Such methods are expensive, energy inefficient, and take up more transmitter space due to the physical size of filters. Alternatively, feed forward circuits have been used to cancel distortion in a transmitter as known in the industry, as shown in FIG. 1. An input signal is amplified by a main power amplifier (PA) 102 that outputs an amplified version of the input signal plus distortion caused by non-linearities in the main PA 102, which is input to a first delay 104. A first coupler 108 provides a tap off the analog input signal to a second delay 110 that is matched to the delay through the main amplifier 102. The second delay 110 outputs a reduced amplitude delayed version of the analog input signal to a combiner 114. A second coupler 112 provides a tap off the output of the main PA 102, which is an amplified version of the input signal plus distortion, to the combiner 114 that subtracts the reduced amplitude delayed version of the input signal from the reduced version of the amplified version of the input signal plus distortion to cancel the input signal and output a distortion signal. The distortion signal is amplified by an error power amplifier 116. The first delay 104 is matched to the delay through the error power amplifier 116 to align the amplified distortion signal in time with the amplified version of the input signal plus distortion in order for the combiner 106 to cancel the amplified distortion signal from the delayed amplified version of the input signal plus distortion. The output signal from the combiner 106 is an amplified version of the input signal with distortion removed or reduced.

This section is intended to introduce the reader to various aspects of art, which may be related to various aspects of the present disclosure that are described and/or claimed below. This discussion is believed to be helpful in providing the reader with background information to facilitate a better understanding of the various aspects of the systems and methods described herein. Accordingly, it should be understood that these statements are to be read in this light, and not as admissions of prior art.

### SUMMARY

A method includes receiving, by a transmitter integrated circuit (IC) having a serial data communications interface, a digital transmit signal, and generating a first signal that is an analog radio frequency (RF) modulated signal based on the digital transmit signal and a second signal that is a phase-offset version of the first signal. An amplified signal is generated by amplifying the first signal and includes an amplified version of the first signal and an out-of-band distortion signal. A reduced-power signal is generated from the amplified signal. The reduced-power signal is combined with (e.g., subtracted from) the second signal to output a distortion cancellation signal. An amplified distortion cancellation signal is generated by amplifying the distortion cancellation signal using an error amplifier. The amplified distortion cancellation signal and a delayed version of the amplified signal are combined to output an amplified version of the first signal with reduced distortion. An apparatus comprises a transmitter integrated circuit (IC) having a serial data communications interface, at least a first digital signal processing circuit and a second digital signal processing circuit, and at least a first digitally controlled modulator and a second digitally controlled modulator, the transmitter IC configured to receive a baseband in-phase and quadrature (IQ) digital signal via the serial data communications interface and to responsively generate, using the first digital signal processing circuit and the first digitally controlled modulator, a first analog radio frequency (RF) modulated signal, and, using the second digital signal processing circuit and the second digitally controlled modulator, a second analog RF modulated signal that is a phase-offset replica of the first analog RF modulated signal; a first amplifier, operably coupled to the transmitter IC and configured to receive the first analog RF signal and to output, at a first amplifier output, an amplified analog RF signal and an out-of-band distortion signal; a first signal coupler, operably coupled to the first amplifier output and configured to generate a reduced-power signal comprising a reduced-power amplified analog RF signal and a reduced-power out-of-band distortion signal; a first signal combiner, operably coupled to the transmitter IC and to the first signal coupler, and configured to cancel the reduced-power amplified RF signal using the second analog RF modulated signal and output a distortion cancellation signal; a second amplifier, operably coupled to the first signal combiner and configured to generate an amplified distortion cancellation signal by amplifying the distortion cancellation signal; and a second signal combiner, operably coupled to the second amplifier and to the first amplifier and configured to cancel the out-of-band distortion signal using the amplified distortion cancellation signal and to output the amplified analog RF signal with reduced out-of-band distortion.

References in the specification to “one embodiment,” “an embodiment,” “an example embodiment,” and the like indicate that the embodiment described may include a particular feature, structure, or characteristic; but not every embodiment necessarily includes that particular feature, structure, or characteristic. Moreover, such phrases are not necessarily referring to the same embodiment. Further, when a particular feature, structure, or characteristic is described in connection with an embodiment, such feature, structure, or characteristic may be used in connection with other embodiments whether or not explicitly described.

### BRIEF DESCRIPTION OF THE FIGURES

FIG. 1 illustrates use of a feedback loop to cancel distortion in a transmitter as known in the industry.

FIG. 2 depicts a feedforward distortion cancellation apparatus for use with a power amplifier in accordance with at least one embodiment.

FIG. 3 depicts a graph showing cancellation using correct signal time alignment in accordance with at least one embodiment.

FIG. 4 depicts a graph showing deficient signal cancellation caused by incorrect time alignment in accordance with at least one embodiment.

FIG. 5 depicts a feedforward distortion cancellation apparatus for use with a Doherty power amplifier in accordance with at least one embodiment.

FIG. 6 depicts a feedforward distortion cancellation apparatus for use with a Doherty power amplifier and an error power amplifier in the form of a balanced power amplifier in accordance with at least one embodiment.

FIG. 7 depicts a feedforward distortion cancellation apparatus for use with a simplified Doherty power amplifier in accordance with at least one embodiment.

FIG. 8 is a transceiver device architecture for forming groups of serially-connected transceivers, where each transceiver includes an integrated digital signal processor for converting frequency domain digital data to/from time domain digital data, a plurality of integrated digital power amplifiers for converting digital baseband time domain signals to amplified analog RF signals, and analog RF downconverters and analog to digital converters in accordance with at least one embodiment.

FIG. 9A and FIG. 9B are a block diagram of the transceiver device transmit circuits that generate a plurality of amplified multi-carrier RF signals, and of the transceiver device receive circuits that generate a plurality of downconverted and sampled OFDM signals, respectively, in accordance with at least one embodiment.

FIG. 10 is a flowchart illustrating a method of distortion cancellation for an amplified signal in accordance with at least one embodiment.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments herein. The apparatus and method components have been represented where appropriate by conventional symbols in the drawings, showing only those specific details that are pertinent to understanding the embodiments of the present embodiments so as not to obscure the disclosure with details that will be readily apparent to those of ordinary skill in the art having the benefit of the description herein.

### DETAILED DESCRIPTION

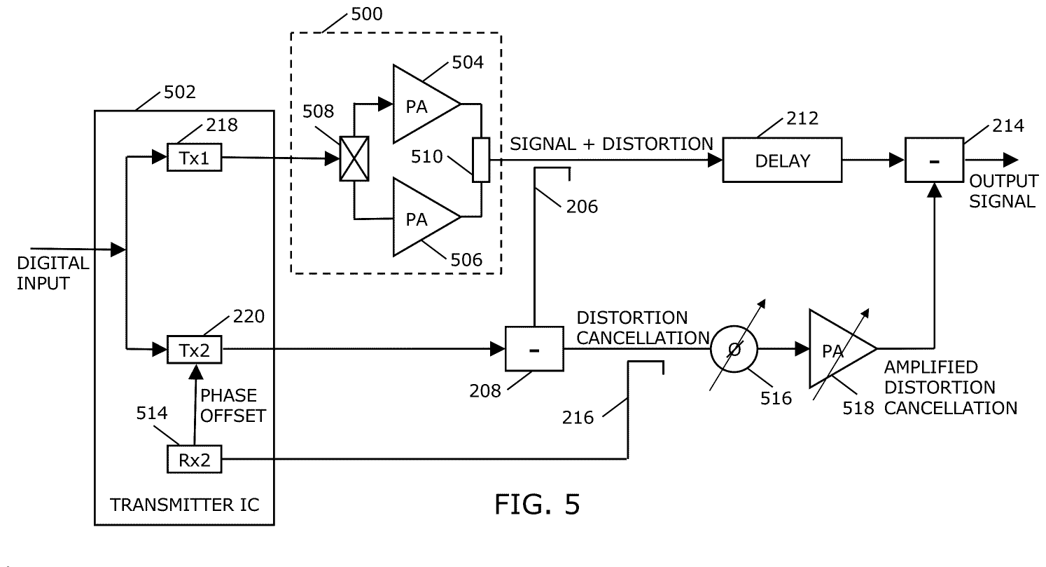

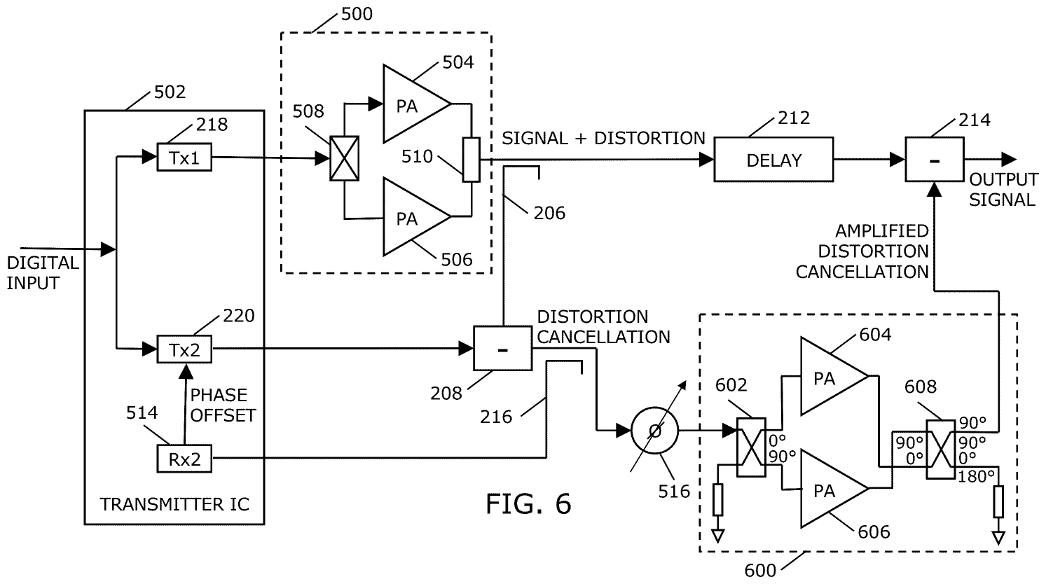

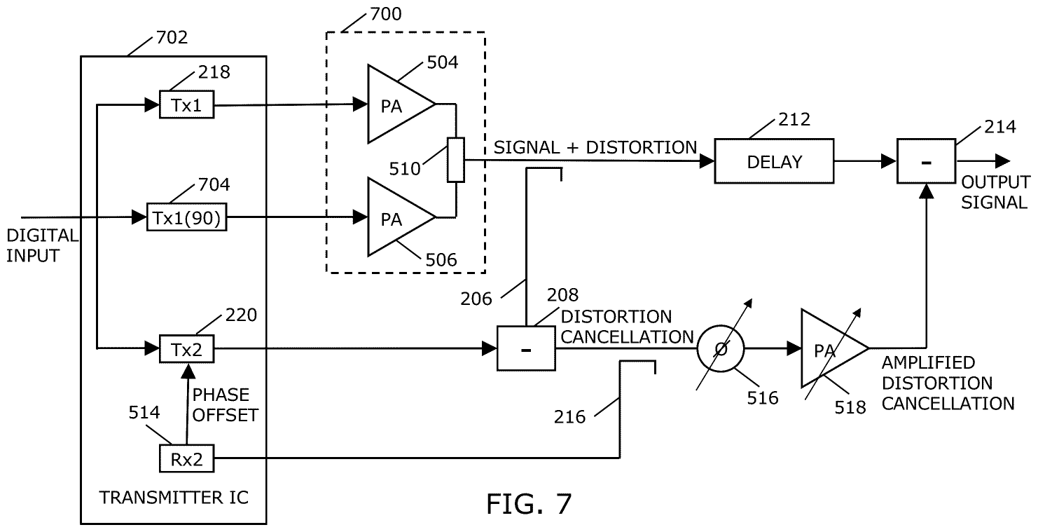

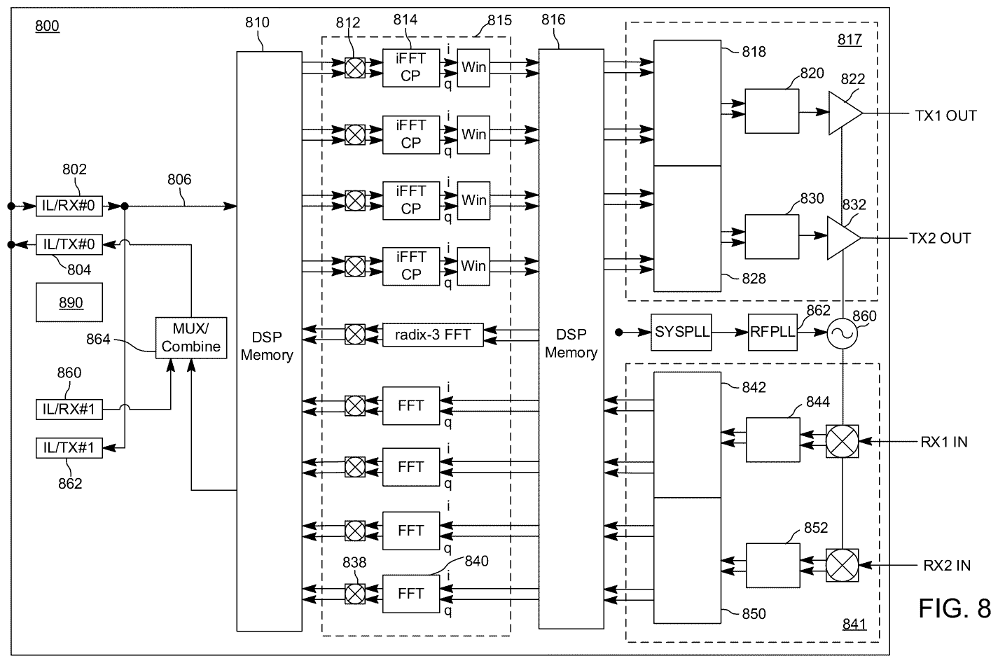

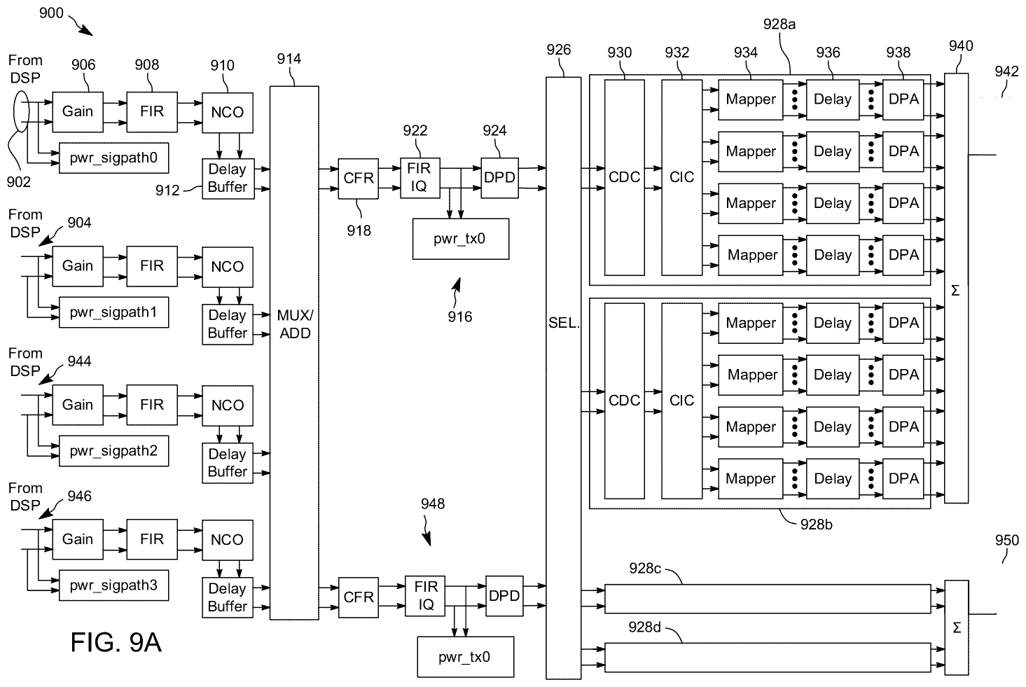

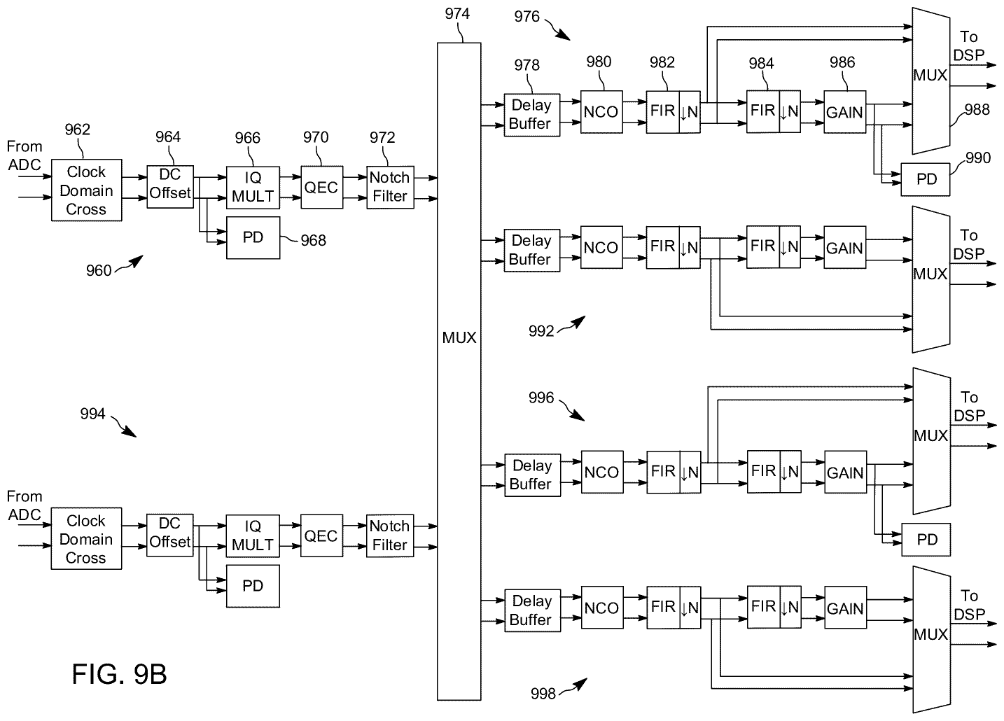

A feedforward distortion cancellation apparatus for use with a power amplifier in accordance with at least one embodiment is shown in FIG. 2. A digital input signal is input to a transmitter including the apparatus of FIG. 2, FIG. 5, FIG. 6, and FIG. 7. The digital input signal is input to a transmitter integrated circuit (IC) 202 including, as shown in FIG. 8, a serial data communications interface 802, at least a first digital signal processing circuit 818, 820 and a second digital signal processing circuit 828, 830, and at least a first digitally controlled modulator 822 and a second digitally controlled modulator 832. The transmitter IC 202 is configured to receive the digital input signal in the form of a baseband in-phase and quadrature (IQ) digital signal via the serial data communications interface 802. The transmitter IC 202 includes a first transmitter section Tx1 218 that includes the first digital signal processing circuit and the first digitally controlled modulator. The transmitter IC 202 also includes a second transmitter section Tx2 220 that includes the second digital signal processing circuit and the second digitally controlled modulator. Additional details regarding the transmitter IC 202, 502, 702 are found in FIG. 8, FIG. 9A, and FIG. 9B and the associated text below.

In response to receiving the digital input signal, a first analog radio frequency (RF) modulated signal is generated using the first digital signal processing circuit and the first digitally controlled modulator, and a second analog RF modulated signal that is a phase-offset replica of the first analog RF modulated signal is generated using the second digital signal processing circuit and the second digitally controlled modulator. The transmitter IC 202 outputs analog RF modulated signals, such as an Orthogonal Frequency-Division Multiplexing (OFDM) signals.

The first analog RF modulated signal is input to a main power amplifier 204 that amplifies the first analog RF modulated signal and outputs an amplified analog RF signal and an out-of-band distortion signal. The out-of-band distortion signal may be caused, for example, by non-linearities or other aspects of the main PA 204. A signal coupler 206 is operably coupled to the main power amplifier 204 output to tap or monitor the amplified analog RF signal and the out-of-band distortion signal. The signal coupler 206 is configured to generate a reduced-power signal comprising a reduced-power amplified analog RF signal and a reduced-power out-of-band distortion signal. The reduced-power amplified analog RF signal and the reduced-power out-of-band distortion signal may be, for example, 10 dB to 20 dB down from the amplified analog RF signal and the out-of-band distortion signal, respectively.

The reduced-power signal and the second analog RF modulated signal are input to a signal combiner 208 that combines these signals to cancel the reduced-power amplified RF signal using the second analog RF modulated signal (the phase-offset replica of the first analog RF modulated signal) and outputs a distortion cancellation signal. The second analog RF modulated signal is advantageously reduced in magnitude to a power level that matches the power level of the reduced power signal to facilitate cancellation of the second analog RF modulated signal at the signal combiner 208. The second transmitter section Tx2 220 of the transmitter IC 202 is advantageously configured to output the second analog RF modulated signal at the power level of the reduced power signal. Note that the second analog RF signal may also be inverted (180° offset) by the transmitter section 220 to facilitate signal cancellation in the signal combiner 208.

The distortion cancellation signal is input to a second power amplifier 210, referred to as an error amplifier or error PA. The error PA 210 is configured to generate an amplified distortion cancellation signal by amplifying the distortion cancellation signal according to the gain factor of the error PA 210. The error PA 210 advantageously amplifies the distortion cancellation signal to match the power level of the out-of-band distortion of the amplified analog RF signal to remove the out-of-band distortion signal more accurately. The gain of the error PA 210 may be, for example, 10 dB to 20 db and may be adjustable to more accurately remove the out-of-band distortion added by the main PA 204.

The amplified analog RF signal and the out-of-band distortion signal are input to a delay 212 that provides a delay that matches the delay of a signal that propagates through the error PA 210. The delay 212 aligns, in time, the amplified analog RF signal and the out-of-band distortion signal with the amplified distortion cancellation signal. The amount or time period of the delay 212 may be set at the manufacturing stage, and/or may be calibrated using a calibration procedure.

The amplified distortion cancellation signal is input to a second signal combiner 214 that is operably coupled to the amplifiers 204, 210. The second signal combiner 214 is configured to cancel the out-of-band distortion signal using the amplified distortion cancellation signal and to output the amplified analog RF signal with reduced out-of-band distortion. The output signal of the second signal combiner 214 may be provided, for example, to an antenna or antenna array. By cancelling the out-of-band distortion with the feedforward method and apparatus as shown, additional filters are not needed to remove out-of-band distortion, which filters may be expensive, energy-consuming, and take up valuable space in the transmitter.

A second signal coupler 216 is operably coupled to the first signal combiner 208 output that generates the distortion cancellation signal. The second signal coupler 216 is configured to generate a monitor signal from the distortion cancellation signal. The monitor signal may be, for example, a measurement of a power level of the distortion cancellation signal, which measurement may be taken periodically or continuously. The transmitter IC monitor 222 processes the monitor signal to determine a value of phase offset or time delay for the second analog RF modulated signal. The phase offset or time delay is utilized to time align the second analog RF modulated signal with the reduced power signal input to the first signal combiner 208. The value of phase offset is adjusted based on a measured power of the distortion cancellation signal obtained by coupler 216, for example, by the monitor 222. The phase offset or time delay is input to the second transmitter section Tx2 220 that applies the phase offset to the digital input signal to generate the second analog RF modulated signal, which is a phase offset replica of the first analog RF modulated signal. Additional details regarding determining and adjusting phase offset or time delay are found in FIG. 8, FIG. 9A, and FIG. 9B and the associated description below.

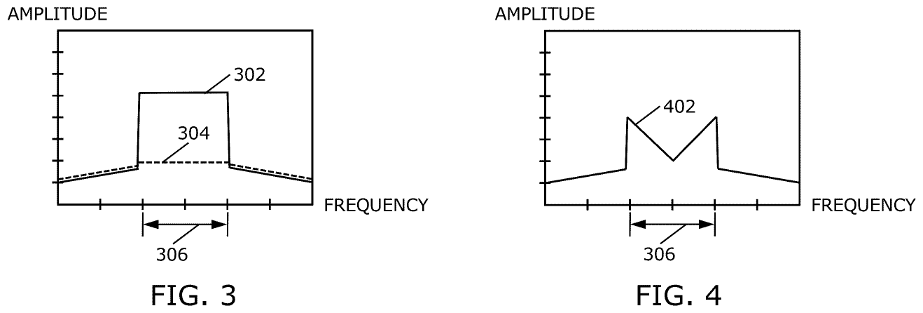

In one embodiment, the value of phase offset is adjusted until a magnitude of the distortion cancellation signal is reduced or minimized. The monitor 222 or alternatively the receiver section Rx2 514 determines the value of phase offset. The phase offset or time delay applied to the second analog RF modulated signal is determined from the monitor signal and adjusted until the second analog RF modulated signal is aligned in time with the reduced power signal 302, such as shown in FIG. 3, which shows signal cancellation using correct signal time alignment to obtain the distortion cancellation signal 304. The output of the signal combiner 208 is tapped to provide the monitor signal. The amplified analog RF signal 302 has an amplitude and desired bandwidth 306 as shown in FIG. 3, which also shows the out-of-band distortion outside of bandwidth 306. The distortion cancellation signal 304 is shown superimposed on the amplified analog RF signal 302, and when combined (i.e., subtracted from) signal 302, provides a lower distortion signal level outside of bandwidth 306. When the reduced power signal is aligned in time or synchronized with the second analog RF modulated signal, the second analog RF modulated signal cancels the reduced power component of the amplified analog RF modulated signal from the reduced power signal, resulting in a distortion cancellation signal 304 that is very small in magnitude compared to the power level of the amplified analog RF modulated signal as shown in FIG. 3.

Adjusting of the phase offset or time delay is performed by regularly monitoring the distortion cancellation signal until the distortion cancellation signal includes primarily the distortion components, without components of the amplified analog RF signal. When the first analog RF modulated signal and second analog RF modulated signal are out of phase, synchronization, or time alignment, then a significant portion of the first analog RF modulated signal is not cancelled from the output of the signal combiner 208, such as shown in FIG. 4, which shows insufficient signal cancellation caused by incorrect time alignment. The monitor signal may be measured, for example, at the output of the signal combiner 208. When the amplified analog RF signal is not completely cancelled from the first signal combiner 208 output, the monitor signal 402 includes part of the amplified analog RF signal that has a significantly higher amplitude than the distortion component of the distortion cancellation signal. Thus, measuring the power level or energy in the first signal combiner 208 output may be useful to identify when the reduced power signal and second analog RF modulated signal are aligned. The monitor signal is monitored, and the value of the phase offset is adjusted until the monitor signal is reduced or minimized, such as illustrated by the dashed line of the distortion cancellation signal 304 superimposed in FIG. 3.

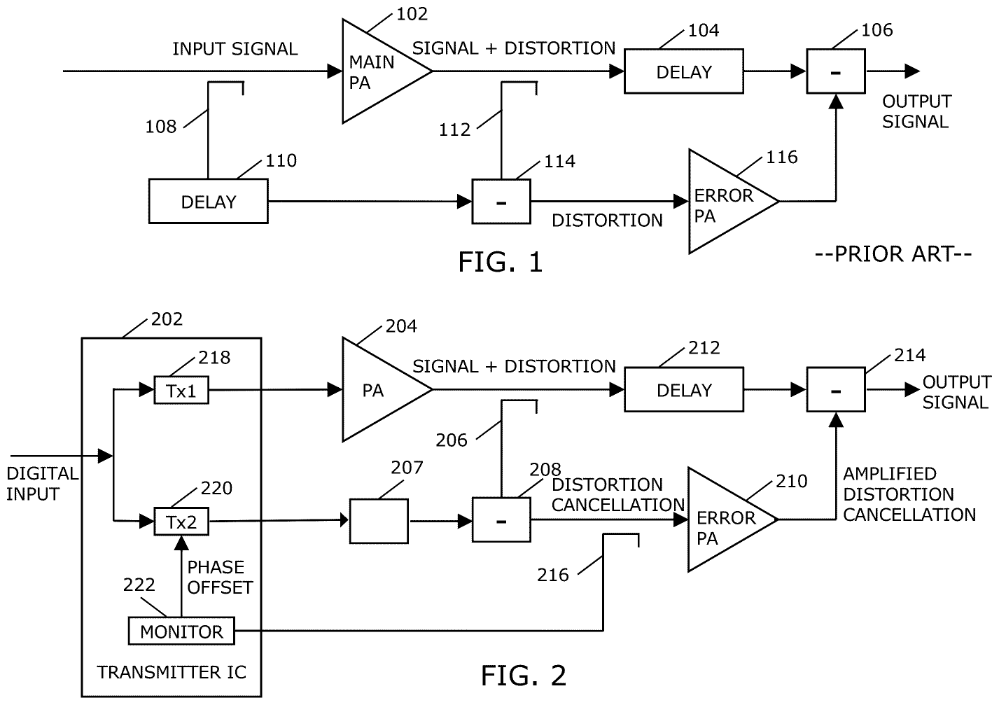

The phase offset is calculated and provided as a digital baseband input to the second transmitter section Tx2 220 that applies the phase offset to generate and output the second analog RF modulated signal as a phase-offset replica of the first analog RF modulated signal. Because a second separate analog RF modulated signal is generated, rather than tapping off a single analog RF modulated signal for cancellation as shown in FIG. 1, the phase offset and power level of the second analog RF modulated signal may be separately adjusted to align the signal components of the second analog RF modulated signal with the reduced-power amplified analog RF signal to more completely cancel the signal components and more fully isolate the distortion signal caused by the main PA 204. Thus, in one embodiment, the phase of the second analog RF modulated signal may be adjusted to reduce the power level of the monitor signal, and then the magnitude of the second analog RF modulated signal may be adjusted to improve the signal cancellation and to further reduce the power level of the monitor signal to better isolate the out-of-band distortion signal for use in distortion cancellation. In some embodiments, the phase and amplitude adjustments may be iterated to achieve further isolation of the out of band distortion signal. In some embodiments, the second RF signal may be bandpass filtered by filter 207 to further remove signal power adjacent to the desired modulated signal of the cancellation signal generated by transmitter 220. In addition, transmitter 220 may perform pre-emphasis signal processing to account for any in-band signal distortion caused by bandpass filter 207. During a calibration step, for example, the filtered signal from filter 207 may be measured by coupler 216 and the monitor receiver may compare it the original Tx2 transmit signal to determine the in-band distortion effects, which may then be used to generate a pre-emphasis compensation. In some embodiments, the bandpass filter 207 may be a low-cost “handset” type filter such as a SAW filter.

An alternative feedforward distortion cancellation apparatus for use with a Doherty power amplifier is shown in FIG. 5. The Doherty amplifier 500 has two amplifiers, a peaking amplifier 504 and a carrier amplifier 506, with inputs that are phase offset by 90 degrees by a quadrature hybrid circuit 508. The two amplifier's 504, 506 outputs are combined with a combiner 510, which may also take the form of a quadrature hybrid coupler, that provides a 90-degree phase offset that further offsets the phase of the amplifier's 504, 506 outputs to constructively add the outputs of each amplifier 504, 506. Doherty power amplifiers may be utilized on input signals with higher peak-to-average power ratios to attain greater linearity than a single amplifier while maintaining sufficient power efficiency.

The transmitter IC 502 is configured to receive the digital input signal in the form of a baseband in-phase and quadrature (IQ) digital signal via the serial data communications interface 802. The transmitter IC 502 includes the first transmitter section Tx1 218 that includes the first digital signal processing circuit and the first digitally controlled modulator and the second transmitter section Tx2 220 that includes the second digital signal processing circuit and the second digitally controlled modulator as described above.

The first analog RF modulated signal is input to the Doherty amplifier 500 that amplifies the first analog RF modulated signal and outputs an amplified analog RF signal and an out-of-band distortion signal. The out-of-band distortion signal may be caused, for example, by non-linearities or other aspects of the Doherty amplifier 500. A signal coupler 206 is operably coupled to the Doherty amplifier 500 output to tap or monitor the amplified analog RF signal and the out-of-band distortion signal. The signal coupler 206 is configured to generate a reduced-power signal comprising a reduced-power amplified analog RF signal and a reduced-power out-of-band distortion signal. The reduced-power amplified analog RF signal and the reduced-power out-of-band distortion signal may be, for example, 10 dB to 20 dB down from the amplified analog RF signal and the out-of-band distortion signal, respectively.

The reduced-power signal and the second analog RF modulated signal are input to a signal combiner 208 that combines these signals to cancel the reduced-power amplified RF signal using the second analog RF modulated signal (the phase-offset and amplitude adjusted replica of the first analog RF modulated signal) and outputs a distortion cancellation signal. The second analog RF modulated signal is advantageously reduced in magnitude to a power level that matches the power level of the reduced power signal to facilitate cancellation of the first analog RF modulated signal at the signal combiner 208. The second transmitter section Tx2 220 of the transmitter IC 202 is advantageously configured to output the second analog RF modulated signal at the power level of the reduced power signal. Furthermore, in some embodiments, an RF bandpass filter may be applied to the second analog RF modulated signal as described above with respect to filter 207 of FIG. 2, with the transmitter 220 performing pre-emphasis signal processing.

In some embodiments, once the distortion cancellation signal has been successfully isolated, it may be desirable to further adjust its phase to account for any delays associated with the error PA (and/or static delay element 212) for proper distortion cancellation at the signal combiner 214 output. The distortion cancellation signal is input to an adjustable phase adjuster 516 that outputs a phase adjusted signal that is input to an adjustable power amplifier 518, also referred to as an adjustable error PA. The adjustable error PA 518 is configured to generate an amplified distortion cancellation signal by amplifying the distortion cancellation signal according to the gain factor of the adjustable error PA 518, which gain factor may be adjustable. The error PA 518 advantageously amplifies the distortion cancellation signal to match the power level of the out-of-band distortion component of the amplified analog RF signal to remove the out-of-band distortion signal more accurately. The gain of the error PA 210 may be, for example, 10 dB to 20 db and is adjustable to more accurately remove the out-of-band distortion added by the main PA 204. Alternatively, the adjustable error PA 518 may be configured as a balanced amplifier or another type of amplifier.

The amplified analog RF signal and the out-of-band distortion signal are input to a delay 212 that provides a delay that matches the delay of a signal that propagates through the error PA 210. The delay 212 aligns, in time, the amplified analog RF signal and the out-of-band distortion signal with the amplified distortion cancellation signal. The amount or time period of the delay 212 may be set at the manufacturing stage.

The amplified distortion cancellation signal is input to the second signal combiner 214 that is operably coupled to the amplifiers 500, 518. The second signal combiner 214 is configured to cancel the out-of-band distortion signal using the amplified distortion cancellation signal and to output the amplified analog RF signal with reduced out-of-band distortion. The output signal of the second signal combiner 214 may be provided, for example, to an antenna or antenna array. By cancelling the out-of-band distortion with the feedforward method and apparatus as shown, additional filters are not needed to remove out-of-band distortion, which filters may be expensive, energy-consuming, and take up valuable space in the transmitter.

A second signal coupler 216 is operably coupled to the first signal combiner 208 output that generates the distortion cancellation signal. The second signal coupler 216 is configured to generate the monitor signal from the distortion cancellation signal. The monitor signal may be, for example, a measurement of a power level of the distortion cancellation signal, which measurement may be taken periodically or continuously. The receiver section Rx2 514 of the transmitter IC 502 processes the monitor signal to determine a value of phase offset or time delay for the second analog RF modulated signal. The phase offset or time delay is utilized to time align the second analog RF modulated signal with the reduced power signal input to the first signal combiner 208. The value of phase offset is adjusted based on a measured power of the distortion cancellation signal, for example, by the monitor 222. The phase offset or time delay is input to the second transmitter section Tx2 220 that applies the phase offset to the digital input signal to generate the second analog RF modulated signal, which is a phase offset replica of the first analog RF modulated signal.

While some embodiments use a power measurement block 222 to obtain the power level of the monitor signal to identify sufficient transmit signal cancellation, some embodiments such as transmitter IC 502 include a third digital signal processing circuit and a demodulator within the receiver Rx2 514. The third digital signal processing circuit and the demodulator process the monitor signal to generate the phase offset that is input to the second digital signal processing circuit for utilization in generating the phase-offset replica of the first analog RF modulated signal. The monitor signal may be processed, for example, by down-converting the monitor signal to baseband for further signal analysis. The third digital signal processing circuit may perform a fast Fourier transform (FFT) to measure the power of one or more frequency bands of the monitor signal. The FFT may be used to identify when the distortion cancellation signal has very little energy within the frequency spectrum of the desired analog signal, indicating sufficient signal cancellation within signal bandwidth 306. Thus, the receiver Rx2 514 may measure the energy of the signal combiner 208 output across the spectrum or bandwidth of the desired analog signal. The receiver Rx2 514 generates a phase offset from the monitor signal and adjusts the phase offset or time delay until the second analog RF modulated signal is aligned in time with the reduced amplitude signal, such as shown in signal 304 in FIG. 3, which shows signal cancellation using correct signal time alignment as described above. The monitor signal may be measured, for example, at the output of the signal combiner 208. Additional details regarding determining and adjusting phase offset or time delay are found in FIG. 8, FIG. 9A, and FIG. 9B and the associated text below.

The phase offset is input to the second transmitter section Tx2 220 that applies the phase offset to generate and output the second analog RF modulated signal as a phase-offset replica of the first analog RF modulated signal.

A feedforward distortion cancellation apparatus for use with a Doherty power amplifier and an error power amplifier in the form of a balanced power amplifier is shown in FIG. 6. The operation of the apparatus of FIG. 6 is similar to that of FIG. 5.

The error PA in FIG. 6 is a balanced amplifier 600 that includes two amplifiers 604, 606, advantageously having similar characteristics such as gain and matched reflection coefficients on their inputs and outputs. The balanced amplifier 600 also includes two directional couplers 602, 608 also known as hybrid couplers, quadrature couplers, or −3 dB couplers. Each coupler is advantageously a 90-degree coupler. The distortion cancellation signal output by the signal combiner 208 is input to the adjustable phase adjuster 516 that outputs a phase-adjusted signal that is input to the input coupler 602. The input coupler 602 advantageously divides the phase-adjusted signal into two paths of equal power, one path entering each amplifier 604, 606, with a 90-degree phase offset between the inputs of the amplifiers 604, 606. The input coupler 602 may be implemented with discrete components, for example, with the amplifiers 604, 606. The outputs of the two amplifiers 604, 606 are input to the output coupler 608. The phase between the output ports of the output coupler 608 is 90 degrees. The output coupler 608 provides a 90-degree phase shift that offsets the phase offset introduced by the input coupler 602. The output coupler 608 adds the outputs of the two amplifiers 604, 606 at one output port using constructive interference and uses destructive interference to combine the outputs of the two amplifiers 604, 606 at the other output port. The output coupler 608 outputs an amplified distortion cancellation signal to the second signal combiner 214 that is configured to cancel the out-of-band distortion signal using the amplified distortion cancellation signal and to provide an output signal that is the amplified analog RF signal with reduced out-of-band distortion. Balanced amplifiers provide advantages such as good impedance matching characteristics, power matching, signal rejection from signals being fed back from the final signal combiner 214, and output power performance.

An alternative feedforward distortion cancellation apparatus for use with a simplified Doherty power amplifier is shown in FIG. 7. The operation of the apparatus of FIG. 7 is similar to that of FIG. 5 with the following exceptions.

No input quadrature hybrid circuit is utilized for the Doherty amplifier 700. The output of the first transmitter section Tx1 218 of the transmitter IC 702 is input to the peaking amplifier 504 of the Doherty amplifier 700. A 90 degree offset transmitter section Tx1 704 includes a fourth digital signal processing circuit and a third digitally controlled modulator that processes the digital input signal and generates a 90-degree offset replica of the first analog radio frequency (RF) modulated signal, which is input to the carrier amplifier 506 of the Doherty amplifier 700. In the embodiment of FIG. 7, the carrier component and the peaking component are generated independently and directly from the digital source data, rather than by analog RF signal splitting. The two signals (carrier and peaking components) are thus not subject to the distortion associated with a quadrature hybrid splitter, including, e.g., signal degradation such as imprecise phase relationships between the two components, added noise, signal attenuation, and so forth. The phases of the two transmit signals from transmitter portions 218, 704, may be further calibrated to provide phase matched signals at the combiner 510. Furthermore, in some embodiments, an RF bandpass filter may be applied to the second analog RF modulated signal as described above with respect to filter 207 of FIG. 2, with the transmitter 220 performing pre-emphasis signal processing.

FIG. 8 depicts a block diagram of a transceiver IC device architecture, also referred to as a transmitter IC, which is also suitable for forming groups of serially-connected transceivers, including transmitter and receiver arrays. The transceiver IC is suitable for operation in a frequency division duplex (FDD) mode and in a time division duplex (TDD) mode. Each transceiver integrated circuit (IC) 800 includes multiple signal processing paths for both transmit signal processing and receive signal processing. For downlink (DL) transmit signal processing, transceiver IC 800 includes a serial data receiver RX #0 802 for receiving frequency domain In-phase and Quadrature (IQ) data packets via serial data receiver 802. The serial data receiver 802 includes a data buffer for storing a number of deserialized data words, and data analysis circuitry to perform packet header analysis, to determine if the received packet is intended for processing by the current transceiver IC and/or if the received packet is intended for processing by one or more other transceiver ICs, in which case the received packet may be retransmitted via serial data transmitter 862 to another transceiver in the transceiver IC subarray. In the event that the packet is to be processed locally, the packet is forwarded via path 806, such as via a memory storage or direct memory access (DMA) operation, to digital signal processor (DSP) memory 810 that is accessible to the integrated DSP 815. In an alternative embodiment, the header inspection may be performed by the DSP 815, which places the data in DSP memory 810 designated for retransmission via transmitter TX #1 862, which may be a SerDes transmitter.

The DSP 815 includes programming stored in non-volatile memory that when executed causes the DSP 815 to execute an algorithm 814 for converting frequency domain digital IQ data to time domain digital data. The stored algorithm instructions contain processor instructions for an inverse fast-Fourier Transform (iFFT) operation 814, and further includes instructions for extending the converted data by the addition of a cyclic prefix (CP).

Phase offset or time delay may be obtained through baseband signal processing without adjusting any signal component directly in the analog domain (including not adjusting voltage-controlled oscillator (VCO) phases).

The relationship between a time delay and the corresponding phase change of a signal is dependent upon the frequency of the signal. A given time delay of a signal amounts to a linear phase shift in the frequency content of the signal, such that a given time delay results in lower phase changes of lower frequencies within the signal and higher phase changes at higher frequencies. Thus, for narrow-band signals, a specific time delay roughly translates to a specific phase shift of the signal. But, for wideband signals, such as OFDM signals of 50 or 100 MHz bandwidth or greater, a given time delay affects the phase of the OFDM subcarriers differently.

Thus, phase offsets may be accomplished by various methods carried out by the individual transceivers described herein, including: (i) applying an incremental phase rotation to each subcarrier frequency-domain IQ data point (via, for example, an NCO-based complex multiplier), (ii) applying a constant phase rotation to each subcarrier frequency-domain IQ data point (for example, via a complex multiplication), (iii) applying a constant phase rotation to each sample of the baseband time domain signal (for example, via a complex multiplication), (iv) imposing time delays in the discrete time domain signals of the transmit baseband signals, or, (v) a combination of the above methods. Note that methods (ii) and (iii) will result in some amount of beam squint distortion.

Phase offset or time delay may be implemented by applying a linearly increasing phase rotation across the subcarriers by complex multiplier 812 implemented as a Numerically Controlled Oscillator (NCO). The NCO 812 is configured to provide a sequence of complex numbers having a linearly increasing phase for multiplication by the corresponding sequence of subcarrier frequency-domain IQ data points. For a desired phase offset, the initial phase and the incremental rate at which the phase increases from subcarrier to subcarrier is determined and the values are loaded into the NCO phase accumulator and the FCW register, respectively. The phase increment value may be determined according to one or more various factors, including (i) a desired phase offset or time delay, (ii) subcarrier spacing, and (iii) the carrier frequency, and so forth.

Alternatively, complex multiply 812 may be configured to provide a constant phase rotation to each frequency domain IQ data point prior to transformation via iFFT 814 to implement an approximate time delay to achieve a phase offset. For a desired phase offset, the frequency-domain phase rotation, represented by a single complex number, is determined and the value loaded into the complex multiplier 812. The frequency domain phase value may be determined according to one or more various factors, including the phase offset or time delay, and the carrier frequency.

In some embodiments, phase offset is implemented by applying a constant phase rotation to each sample of the baseband time domain signal (for example, via a complex multiplication). For a desired phase offset, the time-domain phase rotation, represented by a single complex number, is determined and the value loaded into the complex multiplier 906 (which may also simultaneously implement a gain function). The time-domain phase value may be determined according to one or more various factors, including a desired phase offset or time delay.

In some embodiments, phase offset is implemented by imposing time delays in the discrete time domain signals of the transmit baseband signals. For a desired phase offset, the time-domain delay is determined, and the value loaded into the delay buffer 912. The time-domain delay value may be determined according to one or more various factors, including a desired phase offset and the time-domain sample rate. In some embodiments, a fractional delay element may be used to generate samples for sub-sample delay times.

In further embodiments, a combination of the above methods may be used. In one particular embodiment, phase offset may be composed of a coarse adjustment and a fine adjustment, where a coarse phase offset may be implemented by applying a linearly increasing phase rotation across the subcarriers by complex multiplier 812 implemented as an NCO using a limited resolution or limited number of bits, and the fine resolution may be implemented by a further adjustment in the time domain, such as a time delay or a time-domain constant phase rotation.

For the various embodiments of phase adjustments, the phase rotations may be specified by control message(s) provided to the transceiver ICs. The specific phase values may be provided, or a phase index value may be included in the control message, or in the header of the IQ data packet itself. The phase index value may be used to retrieve precomputed phase values from, for example, a look up table.

In some embodiments, the phase offset may be implemented using a combination of linear phase rotations applied in the frequency domain, followed by either a constant phase rotation in the time domain, or a time delay in the time domain after iFFT conversion. In some embodiments, the frequency domain rotations may achieve a coarse phase offset, or an approximation of the desired phase offset, while the time domain rotations may achieve a fine phase offset. This may be particularly useful when larger phase offsets are desired.

Referring back to FIG. 8, the time-domain IQ data is stored in DSP memory 816, which is accessible by transmit time-domain signal processing circuit 817 (further described with respect to FIG. 9A). In the embodiment of FIG. 8, circuit 817 includes two parallel component carrier processing circuits 818, 828 and corresponding time domain signal processing circuits 820, 830, each providing a baseband time-domain OFDM signal (each being a single or multi-component carrier signal) to a corresponding digital power amplifier (DPA) circuit 822, 832.

In one embodiment, the DPAs 822, 832 perform pre-amplification of the RF signals that are applied to an external power amplifier that drives the radiating antenna element(s). The external power amplifiers are distributed across the active antenna panel assembly in an element-wise adjacency. The DPAs 822, 832 are provided with a plurality of RF carrier phases originating from the system phase-locked-loop (SYSPLL), further processed by the synchronized RF PLL 862, which drives the RF carrier generator VCO 860. The selected RF carrier phases are used to switch amplifier cells within the DPAs. As described herein, the specific RF carrier phases, and the respective number of activated cells that determine their relative magnitudes, are selected according to the time-domain IQ data points provided by the signal processing circuits 820, 830.

The transceiver IC 800 also includes in some embodiments a receive time-domain signal processing circuit 841 (further described with respect to FIG. 9B) for downconverting analog RF signals via IQ mixers driven by the VCO 860, and which generate separate baseband I and Q analog signals for sampling by an analog to digital converter (ADC) within circuits 844, 852. The sampled signals are processed by time-domain filtering and downsampling circuits 842, 850. The processed time domain signals are stored in DSP memory 816 for further processing, including CP removal and conversion to the subcarrier-specific frequency domain IQ data via FFT algorithm (“FFT” 840 in FIG. 8). The DSP 815 includes programming stored in non-volatile memory that when executed causes the DSP 815 to execute an algorithm for converting time domain digital data to frequency domain digital IQ data.

FIG. 9A is a block diagram 900 of the time domain signal processing circuit 817. Time domain IQ data is received from DSP memory over lines 902 (and similarly, 904, 944, 946), and is applied to signal path power detector and to a gain unit 906 for adjusting the power level. In some embodiments, the gain multiplier may also include a complex phase that rotates each time domain value by the same phase. This time-domain phase rotation may be used to apply an approximate time delay that can be used to implement a phase offset. While this time-domain phase rotation corresponds to a phase rotation of each constituent subcarrier by the same phase, rather than a linearly incremented phase rotation, this rotation may be sufficiently accurate for bandwidths on the order of 100 MHz in the frequency ranges of the bands used for LTE and 5G signal. The signal is filtered by Finite Impulse Response (FIR) filter stage 908, which also includes one of more interpolation stages to increase the sample rate of the discrete time domain signal. The discrete time digital DL signal is processed by a numerically controlled oscillator (NCO) 910. The NCOs (for example, 910) may be configured to multiply the time domain signal by a complex sinusoid function to perform a frequency shift of the baseband signal to a desired frequency range, such as a separate frequency range that does not overlap with other component carriers. In some embodiments, one transmit signal may be slightly shifted up in frequency, while another transmit signal, such as a separate component carrier provided on connection 904, may be slightly shifted downward with the corresponding NCO, such that the two time-domain signals representing for example, two component carriers, may be added together without the frequency content of one signal overlapping that of the other. The signal is further processed by a delay buffer 912 that allows refined time offset (i.e., phase offset) adjustments of the transmit signal. In some embodiments, the delay buffer 912 is used to provide a per-carrier delay adjustment. The delay buffer 912 compensates for the different processing times of the different supported sub carrier spacing (SCS) and bandwidths. Assuming all the filtering is performed with a FIR filter for every carrier, the adjustable delay per carrier is the difference between the larger delay and the shortest one, on the order of 10 us. However, sharing that function with windowing relaxes that requirement.

Other discrete time domain signals 904, 944, 946, resulting from the frequency domain conversion to the time domain from DSP 815 are similarly processed. The signals may then be combined and/or routed via MUX/ADD circuit 914 to the transmit signal processing circuits 916, 948 for crest factor reduction (for example, CFR 918), further FIR filtering (including further upsampling/interpolation) and IQ multiplication to perform phase adjustments and/or corrections (for example, FIR IQ circuit 922). The signal may also undergo digital pre-distortion (DPD), (via, for example, DPD circuit 924) to correct for phase and amplitude distortion present in the modulator/amplifiers DPA 928a, 928b, for the first signal port 942 from RF signal summer 940 (and for DPA 928c, 928d, for signal port 950). Each section 928a-d of the DPA includes a clock domain crossing circuit 930, Cascaded Integrator-Comb (CIC) filters 932, mapper circuits 934, delay circuits 936 and a final DPA stage 938.

FIG. 9B depicts the receive signal processing portion of the transceiver. Digital samples from the ADCs are received by the clock domain crossing circuit 962 and adjusted for DC offsets by DC offset circuit 964. IQ multiplier 966 may be used to provide an automatic gain control of the baseband time-domain signal in response to power measured by power detector PD 968. Quadrature Error Compensation circuit (QEC 970) provides compensation for frequency dependent quadrature error in the RX analog front-end. In one embodiment, the QEC block 970 divides the time domain signal (having, for example, a sample rate of 245.76 MHz) into 16 frequency bins of 15.36 MHz each. Each frequency bin is added to the mirror frequency bin content shaped by a complex multiplier. Notch filter 972 may be used to reduce any undesired out-of-band signals.

The MUX 974 may be configured to selectively direct the receive signal samples from either path RX0 (960), or RX1 (994) to any or all the RX signal paths 976, 992, 996, or 998. Some examples of different possibilities are: RX0 to all 4 RX signal paths; RX1 to all 4 RX Signal paths; RX0 to RX Signal path 976 and 992 and RX1 to RX Signal path 996 and 998; and RX0 to RX Signal path 976 and RX1 to RX Signal paths 992, 996, and 998. Each RX Signal path includes delay buffers (for example, 978), NCOs (for example, 980), FIR filter and downsamplers (for example, 984, 982), and power detectors (for example, PD 990). Note that gain multipliers (for example, 986), may also implement a constant phase rotation to the time domain signal. In such an embodiment, this is equivalent to a constant phase shift applied to each subcarrier, rather than a linearly increasing phase shift across the subcarriers, but nonetheless provides for an adequate approximation of a time delay for purposes of implementing phase offset. FIR 982 may also include a notch filter for removing a component carrier that is not being processed by the given signal path. In some embodiments, the NCO 980 may be used to apply a time-domain frequency shift that moves the desired component carrier to the low-pass passband of the notch filter 982.

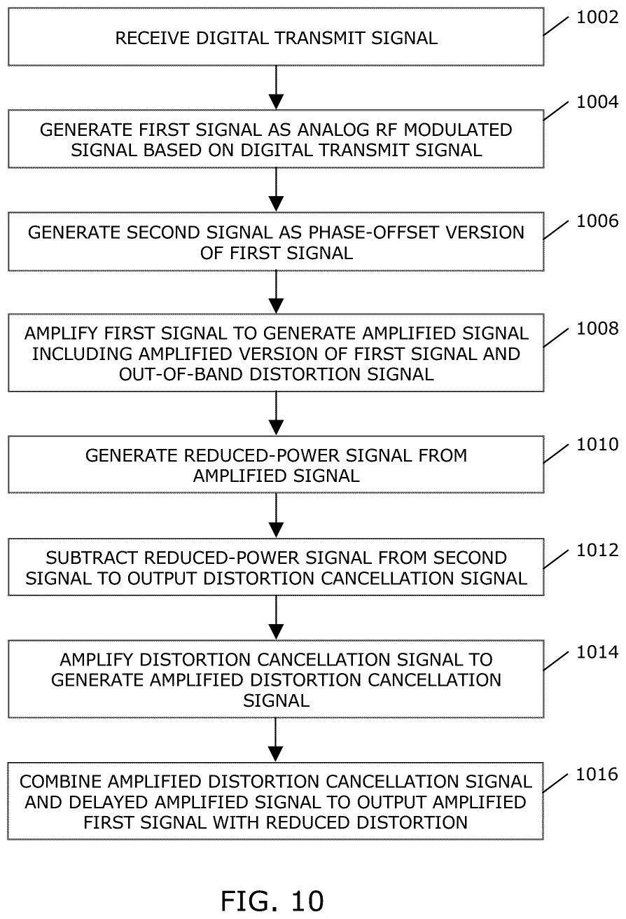

A flowchart illustrating a method of distortion cancellation for an amplified signal is shown in FIG. 10. The method may be performed, for example, by a transmitter integrated circuit (IC) having a serial data communications interface such as described above, for example, with respect to FIG. 2 and FIG. 5 through FIG. 9. A digital transmit signal is received 1002. A first signal is generated 1004 as an analog radio frequency (RF) modulated signal based on the digital transmit signal. A second signal is generated 1006 as a phase-offset version of the first signal. An amplified signal is generated 1008 by amplifying the first signal. The amplified signal may be generated by a linear transmit amplifier, a Doherty amplifier, a balanced amplifier, or other suitable amplifier. The amplified signal includes an amplified version of the first signal and an out-of-band distortion signal. A reduced-power signal is generated 1010 from the amplified signal. The reduced-power signal is subtracted 1012 from the second signal to output a distortion cancellation signal. An amplified distortion cancellation signal is generated 1014 by amplifying the distortion cancellation signal, for example, utilizing an error amplifier. The error amplifier may have adjustable gain and phase.

A monitor signal may be generated from the distortion cancellation signal. A value of phase offset is adjusted based on a measured power of the distortion cancellation signal, for example, as described above. The value of phase offset may be adjusted until a magnitude of the distortion cancellation signal is reduced. The transmitter IC may monitor and adjust the value of the phase offset. The transmitter IC may process the monitor signal into the phase offset that is utilized in generating the phase-offset replica or version of the first analog RF modulated signal. The processing of the monitor signal may comprise performing a fast Fourier transform to measure power of the monitor signal.

The amplified distortion cancellation signal and a delayed version of the amplified signal are combined 1016 to output an amplified version of the first signal with reduced distortion.

Because a second separate analog RF modulated signal is generated as described in the embodiments of FIG. 2, FIG. 5, FIG. 6, and FIG. 7, rather than tapping off a single analog RF modulated signal for cancellation as shown in FIG. 1, the phase offset and power level of the second analog RF modulated signal may be separately adjusted to align the reduced-power out-of-band distortion signal more accurately with the second analog RF modulated signal to more completely cancel the distortion signal caused by the main PA 204 or Doherty PA 500.

The methods may be performed in a different order than shown in the flowcharts or described in the description and may be performed utilizing fewer or or additional processes than shown in the flowcharts. A computer-readable storage medium, which may be a non-transitory computer-readable storage medium, may have stored instructions that are operative, when executed by a processor, to cause a processor or system to perform any of the methods or processes described herein.

The present disclosure may be embodied in other forms without departing from its spirit or essential characteristics. The described embodiments are to be considered as examples, and in all respects are merely illustrative and not restrictive.

What is claimed is:

1. An apparatus comprising:
a transmitter integrated circuit (IC) having a serial data communications interface, at least a first digital signal processing circuit and a second digital signal processing circuit, and at least a first digitally controlled modulator and a second digitally controlled modulator, the transmitter IC configured to receive a baseband in-phase and quadrature (IQ) digital signal via the serial data communications interface and to responsively generate, using the first digital signal processing circuit and the first digitally controlled modulator, a first analog radio frequency (RF) modulated signal, and, using the second digital signal processing circuit and the second digitally controlled modulator, a second analog RF modulated signal that is a phase-offset replica of the first analog RF modulated signal;
a first amplifier, operably coupled to the transmitter IC and configured to receive the first analog RF signal and to output, at a first amplifier output, an amplified analog RF signal and an out-of-band distortion signal;
a first signal coupler, operably coupled to the first amplifier output and configured to generate a reduced-power signal comprising a reduced-power amplified analog RF signal and a reduced-power out-of-band distortion signal;
a first signal combiner, operably coupled to the transmitter IC and to the first signal coupler, and configured to cancel the reduced-power amplified RF signal using the second analog RF modulated signal and output a distortion cancellation signal;
a second amplifier, operably coupled to the first signal combiner and configured to generate an amplified distortion cancellation signal by amplifying the distortion cancellation signal;
a second signal combiner, operably coupled to the second amplifier and to the first amplifier and configured to cancel the out-of-band distortion signal using the amplified distortion cancellation signal and to output the amplified analog RF signal with reduced out-of-band distortion.

2. The apparatus of claim 1, further comprising a second signal coupler, operably coupled to the first signal combiner output and configured to generate a monitor signal from the distortion cancellation signal, wherein a value of phase offset is adjusted based on a measured power of the distortion cancellation signal.

3. The apparatus of claim 2, wherein the value of phase offset is adjusted until a magnitude of the distortion cancellation signal is reduced.

4. The apparatus of claim 2, wherein the transmitter IC performs monitoring and adjusting of the value of the phase offset.

5. The apparatus of claim 4, wherein the transmitter IC further comprises a third digital signal processing circuit and a demodulator, wherein the third digital signal processing circuit and the demodulator process the monitor signal into the phase offset that is input to the first digital signal processing circuit for utilization in generating the phase-offset replica of the first analog RF modulated signal.

6. The apparatus of claim 5, wherein the third digital signal processing circuit performs a fast Fourier transform to measure power of the monitor signal.

7. The apparatus of claim 1, wherein the first amplifier is a Doherty amplifier, and the second amplifier has adjustable gain and phase.

8. The apparatus of claim 1, wherein the first amplifier is a Doherty amplifier, and the second amplifier is a Doherty amplifier.

9. The apparatus of claim 1, wherein the second amplifier is a balanced amplifier.

10. A method comprising:
receiving, by a transmitter integrated circuit (IC) having a serial data communications interface, a digital transmit signal;
generating, at the transmitter IC, a first signal that is an analog radio frequency (RF) modulated signal based on the digital transmit signal;
generating, at the transmitter IC, a second signal that is a phase-offset version of the first signal;
generating an amplified signal by amplifying the first signal, the amplified signal including an amplified version of the first signal and an out-of-band distortion signal;
generating a reduced-power signal from the amplified signal;
subtracting the reduced-power signal from the second signal to output a distortion cancellation signal;
generating, using an error amplifier, an amplified distortion cancellation signal by amplifying the distortion cancellation signal;
combining the amplified distortion cancellation signal and a delayed version of the amplified signal to output an amplified version of the first signal with reduced distortion.

11. The method of claim 10, further comprising generating a monitor signal from the distortion cancellation signal, wherein a value of phase offset is adjusted based on a measured power of the distortion cancellation signal.

12. The method of claim 10, wherein the value of phase offset is adjusted until a magnitude of the distortion cancellation signal is reduced.

13. The apparatus of claim 10, wherein the transmitter IC performs monitoring and adjusting of the value of the phase offset.

14. The method of claim 13, wherein the transmitter IC processes the monitor signal into the phase offset that is utilized in generating the phase-offset replica of the first analog RF modulated signal.

15. The apparatus of claim 14, wherein the processing comprises performing a fast Fourier transform to measure power of the monitor signal.

16. The method of claim 10, wherein the amplified signal is generated by a Doherty amplifier, and the error amplifier has adjustable gain and phase.

17. The method of claim 10, wherein the amplified signal is generated by a Doherty amplifier, and the error amplifier is a Doherty amplifier.

18. The method of claim 10, wherein the error amplifier is a balanced amplifier.
